(19) United States
(12) Patent Application Publication
(10) Pub. No.: US 2025/0157748 A1
(43) Pub. Date: May 15, 2025

(54) SWITCH INCORPORATING EQUIPOTENTIALLY CONNECTED CONTACTS AND METHOD FOR OPERATING A SWITCH

(71) Applicant: Gorlan Team, S.L.U., Vizcaya (ES)

(72) Inventor: Jose Oscar ANDALUZ SORLÍ, Zaragoza (ES)

(21) Appl. No.: 18/938,964

(22) Filed: Nov. 6, 2024

(30) Foreign Application Priority Data
Nov. 10, 2023 (EP) 23383153.6

(51) Int. Cl. H01H 3/00; H01H 1/42; H01H 1/58; H01H 9/36

(52) U.S. Cl. CPC H01H 3/001; H01H 1/42; H01H 1/5822; H01H 9/36; H01H 2009/365

(57) ABSTRACT

A switch capable of withstanding short-circuit currents without being destroyed or deteriorated by the passage of such high currents includes at least one fixed contact and at least one movable contact, wherein the movable contact is displaceable between a closed position of the switch in which the fixed and the movable contacts are electrically connected, and an open position of the switch in which the fixed and movable contacts are separated. The switch includes at least one equipotential connecting member electrically connecting the fixed contact and the movable contact in the closed position of the switch, such that the fixed and the movable contacts are at the same electric potential, and wherein at least a part of the equipotential connecting member is pressed against the fixed contact and/or the movable contact in the closed position of the switch.

### CROSS-REFERENCE TO RELATED APPLICATIONS

This application claims the benefit of European patent application no. 23383153.6, filed on 10 Nov. 2023, the disclosure of which is incorporated herein by reference in its entirety.

### TECHNICAL FIELD

The present disclosure relates in general to electric power switches, especially adapted to withstand short-circuit currents.

The disclosure provides the provision of a switch capable of withstanding short-circuit currents, without being destroyed or deteriorated by the passage of such high currents.

More specifically, the disclosure provides a switch of the above-mentioned type, which can be manufactured with reduced material and reduced cost, and which can be easily retrofitted into existing switch designs.

The disclosure also refers to a method for operating a switch of the above-described type, for switching On and Off an electric current.

### BACKGROUND

The admissible short-time withstand current (Icw) characterizes the ability of an equipment to withstand short-circuit currents, typically very high, for a duration enough to eliminate them by means of circuit breakers or protection devices located downstream of that equipment.

Therefore, this is an essential feature of the circuit disconnector or isolating switch which is located at the head of an electric installation.

The higher the value of the (Icw) withstood by the circuit disconnector, the higher the limit of utilization of the chronometric selectivity.

It must be borne in mind that, both the switchboard in which the circuit disconnector is installed and all the conductors upstream must be able to withstand these currents.

Short-circuit currents produce 2 types of phenomena in a switch:
i) it generates electrodynamic stresses between the different parts of the circuit through which a current circulates. Forces of repulsion or attraction are generated according to the respective directions of the currents; they manifest themselves instantaneously and the resistance of the apparatus to these forces, called “electrodynamic resistance” (TDE) will be characterised by the maximum instantaneous value of the current it can withstand, measured in “peak” KAmperes. Beyond this value, irreversible deformations of the parts or electric arcs occur which may damage the parts concerned.
ii) heating of the parts through which current circulates. This heating is not a function of the instantaneous value of the current, but of its effective value and its duration; the resistance of the switch/disconnector to these phenomena can therefore be expressed in effective KAmperes and in seconds. This heating can generally lead to the welding of the moving contacts to the fixed contacts, which means that the disconnector cannot be switched to the OFF position and no longer fulfils its main function of opening and disconnecting, in order to electrically isolate the circuit.

The “admissible short-time withstand current” is defined in several standards, including IEC 60947-2, which gives it the symbol (Icw).

The associated test makes it possible to test the behavior of a disconnector under both the electrodynamic aspect, when a short-circuit occurs, and under the thermal aspect, by maintaining the current for a given time (normally 0.5 s, 1 s or 3 s).

The maximum peak current is defined by the standard as a function of the effective current; knowledge of the latter is sufficient to define the (Icw).

It is evident that the (Icw) value of a circuit disconnector is limited by the most severe phenomena, whether electrodynamic or thermal, and that this value therefore normally decreases as its duration increases: an (Icw) for 3 seconds is thermally 9 times worse than an (Icw) for 1 second.

At the initial moment of a short-circuit, when the electric current begins to flow through the fixed contacts and to be distributed across the moving contacts, the electrodynamic repulsive forces (Fr) can sometimes be much greater than the force exerted by the contact pressure springs (Fp).

At this point, a levitation of the moving contacts might occur, which temporarily causes a loss of contact pressure or even a disconnection of the connection.

In the case of loss of contact pressure, there is an increase in the contact resistance which causes strong heating in the area, resulting in the melting and welding of the materials that make up the electrical connections, subsequently preventing the circuit breaker from opening as they are strongly welded.

In the event of contact separation, electric arcing occurs which can also cause strong welding between the fixed and moving contacts, making it impossible to open the circuit breaker. Occasionally, if the repulsion forces are much greater than the contact pressure, contact separation occurs due to the repulsion forces, resulting in strong electric arcs which cause a large internal overpressure which often causes the circuit breaker to explode.

This separation of contacts causes the loss of equipotentiality at the junction of the fixed contact with the moving contact. This loss of equipotentiality of the junction causes the potential difference Va-Vb between the junction zone of the fixed contact and the junction zone of the mobile contact to reach a value equal to the maximum voltage of the circuit (380 Vac, 400 Vac) which causes an electric arc whose intensity is the value of (Icw) at that moment, the energy released causes a fire or explosion of the circuit disconnector causing serious damage to installations and even to people.

FIG. 1A shows a conventional switch (1) formed by two fixed contacts (3a,3b) and a movable contact (4) formed by two blades (4a,4b) which in the closed position of the switch are overlapped and in contact with the two fixed contacts (3a,3b). The switch (1) incorporates two pressure springs (2, 2′) which exerts forces (Fp) pressing the two blades (4a,4b) towards the fixed contacts (3a,3b). When a short-circuit occur, a short-circuit current (I) entering the switch through the fixed contact (3a) would split in two currents (I/2) through each one of the blades (4a,4b) as indicated by the dotted arrows in FIG. 1A. These currents generate repulsion forces (Fr) in an opposite direction than the forces (Fp) of the pressure springs (2, 2′), and if they are higher, the blades (4a,4b) would levitate and the equipotentiality between blades (4a,4b) and fixed contact (3a) would be discontinued (FIG. 1B).

The voltage (Va-Vb) shown in FIG. 2A would generate electric arcs as shown in FIGS. 1B & 2C, that in turn might produce welding spots (5a,5b) between blades (4a,4b) and fixed contact (3a) as shown in FIG. 2B.

To partly try to minimize these problems, current state-of-the-art solutions use much more robust contact pressure springs to exert higher forces and reduce this contact separation problem which is caused by strong repulsion forces. In this way, manufacturers try to improve the resilience to a higher (Icw). The U.S. patent publication US 2014/0353136 A1 describes an example of said prior art solution.

The use of more robust springs to increase the force to maintain the fixed contact, makes the kinematics of opening and closing the circuit disconnector more difficult and greater maneuvering efforts are needed, which requires greater constructive demands on the circuit disconnectors to increase their robustness, which in turn increases the thickness of the thermoplastic materials, copper, steel and also increasing the size of the circuit disconnector which results in a greater use of raw materials and their weight and consequently a greater environmental impact and cost.

Therefore, the provision of electric power switches that overcome the above-described shortcomings of the current technology, remains a challenge in this technical field.

### SUMMARY

The disclosure is defined in the attached independent claims, and satisfactorily solves the above-described drawbacks of the prior art, by the provision of a switch capable of withstanding short-circuit currents maintaining its integrity, that is, without being damaged or destroyed, at least, during enough time to allow other protection devices connected downstream, to open the circuit and interrupt the short-circuit current.

Therefore, a first aspect of the disclosure refers to a switch comprising: at least one fixed contact and at least one movable contact, wherein the movable contact is displaceable between a closed position of the switch in which the fixed and the movable contacts are electrically connected so that a current can circulate through the fixed and movable contacts, and an open position of the switch in which the fixed and movable contacts are spaced apart from each other, so that current circulation through the fixed and movable contacts is impeded.

According to the disclosure, the switch further comprising at least one equipotential connecting member electrically connecting the fixed contact and the movable contact in the closed position of the switch. Additionally, a part of the equipotential connecting member is configured to press against the fixed contact and/or the movable contact in the closed position of the switch.

The equipotential connecting member is configured and arranged in the switch, to assure that the fixed and the movable contacts remain connected in the closed position of the switch, even when the fixed and the movable contacts are separated as consequence of repulsion forces caused by a short-circuit current flowing through the switch, so that the fixed and the movable contacts remain at the same electric potential during the short-circuit event, hence preventing the formation of an electric arc between the two contacts.

For that purpose, the equipotential connecting member is configured to maintain the fixed and the movable contacts pressed together in the closed position of the switch, in a way in which it assured that the fixed and the movable contacts remain at the same electric potential, even if they are separated due to repulsion forces caused by a short-circuit current.

In a preferred embodiment, the equipotential connecting member is configured as a clamp or clip that embraces the fixed contact or the movable contact or both in the closed position of the switch, in particular the equipotential connecting member embraces the fixed and/or the movable contacts at the parts of the contacts which are overlapped and in contact in the closed position. In this position, a part of the equipotential connecting member, is placed above the fixed contact or the movable contact or both, so that, when the fixed and movable contacts are separated due to a short-circuit current, they would remain connected by the equipotential connecting member, thereby assuring that both contacts are at the same potential.

Due to the equipotential connecting member, it is assured that the potential difference between the fixed and movable contact is always zero even if they are separated in the closed position of the switch, thus, an electric arc between these two contacts cannot be formed. Therefore, the switch is not affected by the damaging effects of an electric arc between contacts.

The present disclosure is focused on improving the limits of (Icw) by overcoming the severe electrodynamic effects of high short-circuit currents, eliminating the effects of contact repulsion forces at the initial instant of a short-circuit.

Obviously, the equipotential connecting member is arranged and configured such that in the open position of the switch, it is disconnected from the fixed contact or from the movable contact or from both.

In the closed position of the switch, the fixed contact and the movable contact are overlapped and in contact at a contacting surface, and the part of the equipotential connecting member which presses against the fixed contact and/or the movable contact, press in a direction towards that contacting surface.

In a preferred embodiment of the disclosure, the part of the equipotential connecting member which presses against the fixed contact and/or the movable contact, is embodied as a flexible metal plate configured to exert pressure on the fixed contact and/or the movable contact in the closed position of the switch due to its flexible characteristic.

Preferably, the equipotential connecting member is configured to have a part of the equipotential connecting member permanently attached to the fixed contact, and the part of the same which is configured as a flexible metal plate, overlaps the movable contact and press the movable contact towards the fixed contact in the closed position of the switch to assure that the fixed and movable contacts remain connected.

In this way, if the movable contact is separated from the fixed contact in the closed position of the switch, the displacement of the movable contact would flex the equipotential connecting member, which would remain connected to the movable contact.

In a preferred embodiment of the disclosure combinable with other embodiments, the fixed contacts are substantially flat and elongated bodies, each one formed by a rigid metallic piece. Preferably, the switch comprises a first fixed contact and a second fixed contact spaced apart from each other, and the movable contact in the closed position of the switch, is placed in the space in between the first and second fixed contacts and it is electrically connected to the two fixed contacts. The movable contact is composed by two blades embodied as generally flat and elongated bodies, each one formed by a rigid metallic piece, wherein the blades are separated and parallel to each other.

Additionally, the switch comprises first and second equipotential connecting members, respectively connecting the movable contact with the first and second fixed contacts in the closed position of the switch.

In a preferred embodiment of the disclosure combinable with other embodiments, the first and second fixed contacts are aligned in a first direction, and the movable contact is linearly displaceable in a second direction orthogonal to first direction.

Another aspect of the disclosure refers to a multipole switch including an array of switches that open and close simultaneously, wherein each switch is a pole of the multipole switch and each switch is the switch described in any of the previous embodiments. Conventionally, the multipole switch includes a carrier made of an electrically insulating material, and all the movable contacts of the switch are mounted in the carrier so that all the movable contacts move simultaneously between open and closed positions of the multipole switch.

Another aspect of the disclosure refers to a method for operating a switch for switching On and Off an electric current. The method comprises the step of maintaining a fixed contact and a movable contact of the switch at the same electric potential in a closed position of the switch, when the fixed and movable contacts are electrically connected, while a short-circuit current circulates through the switch. Preferably, the switch is the switch of any of the previously described embodiments.

The fixed contact and the movable contact of the switch are maintained at the same electric potential in a closed position of the switch, by clamping and pressing together the fixed and movable contacts by means of an equipotential connecting member made of a flexible metallic plate. The equipotential connecting member embrace and press together the fixed and the movable contact, at the parts of these contacts that are overlapped and in contact. In this way, if the fixed and movable contact are separated apart as consequence of the circulation of short-circuit current through them, the equipotential connecting member remains connected to the fixed and movable contacts thereby assuring that both contacts are at the same potential.

Preferably, the switch of the disclosure is adapted to operate as a circuit disconnector, which advantageously can be used as head circuit disconnector installed at the head of an electrical circuit, for example an electric distribution board, so that its capacity to withstand a high short-circuit currents without being destroyed, provides enough time for other protection devices connected downstream to react to the short-circuit disconnecting its corresponding part of the installation.

### BRIEF DESCRIPTION OF THE DRAWINGS

To complete the description and in order to provide a better understanding of the disclosure, a set of drawings is provided. These drawings form an integral part of the description and illustrate embodiments of the disclosure, which should not be interpreted as restricting the scope of the disclosure, but just as examples of how the disclosure can be carried out. The drawings comprise the following figures:

FIG. 1.—shows in Figure A a top a from elevational view of a power switch of the prior art incorporating leaf spring members to press the movable contact against the fixed contact, wherein the arrows indicate repulsion forces and currents circulating through the contacts; and Figure B is an electric diagram illustrating contacts levitation during a short circuit resulting in the formation of an electric arc.

FIG. 2.—shows in Figure A a perspective view of a switch of the prior art wherein arrows indicate current distribution and circulation through contacts. Figures B and C are electric diagrams illustrating contact levitation and current distribution during a short circuit resulting in the formation of an electric arc.

FIG. 3.—shows in Figure A a perspective view of an exemplary embodiment of a switch according to the present disclosure in an open position of the switch. Figure B is an electric diagram of the switch of Figure A.

FIG. 4.—shows a similar representation of FIG. 3 but in the closed position of the switch, while a nominal current circulates through the switch.

FIG. 5.—shows a similar representation of FIG. 4 but while a short-circuit current circulates through the switch.

FIG. 6.—shows in Figure A a perspective of the switch of the previous figures, and Figures B and C are enlarged details of Figure A, in particular Figure B shows the equipotential connecting member attached to a fixed contact, and Figure C shows the equipotential connecting member alone. Figure D is a cross-sectional view taken at plane A-A in FIG. 6A.

FIGS. 7, 8 and 9.—shows similar representations than FIG. 6, but with alternative configurations of the equipotential connecting member.

FIG. 10.—shows a perspective view of the switch of FIG. 9 including pressure members.

### DETAILED DESCRIPTION OF THE DRAWINGS

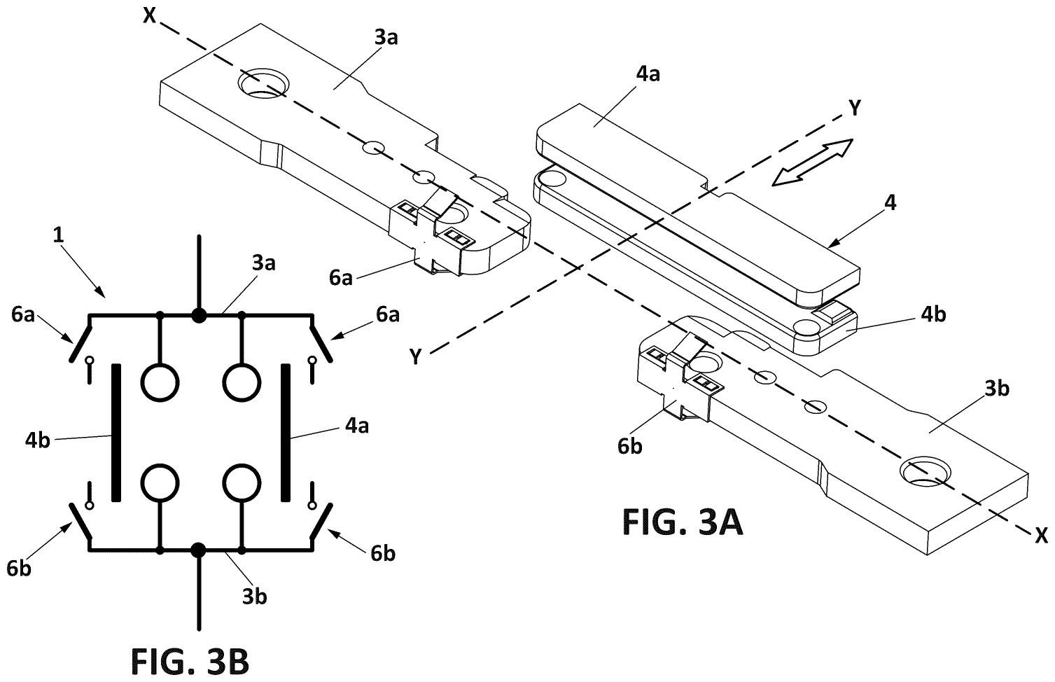

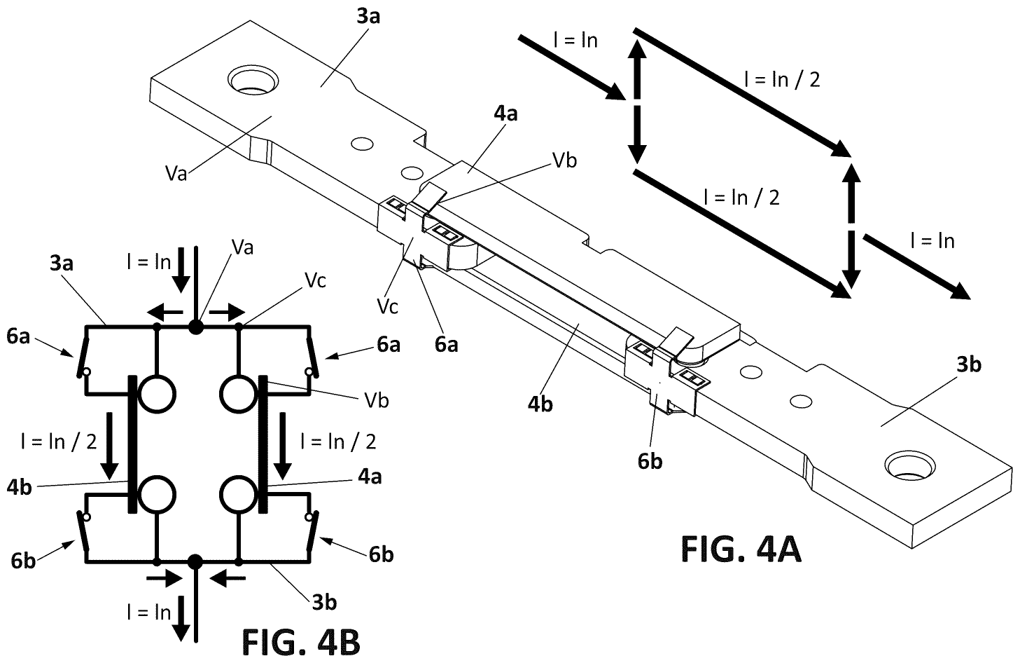

FIGS. 3A, 3B, 4A and 4B show a preferred embodiment of a switch (1) according to the disclosure, which conventionally comprises first and second fixed contacts (3a,3b) formed by generally flat and elongated bodies, each one formed by a rigid metallic piece, and which are aligned in a first direction (X).

The switch (1) also includes a movable contact (4) composed by two blades (4a,4b) also embodied as generally flat and elongated bodies, each one formed by a rigid metallic piece. The blades (4a,4b) are separated and parallel to each other. The movable contact (4) moves in a direction (Y) substantially orthogonal to the direction (X) while transiting between the open position of the switch (1) (FIG. 3A) and the closed position of the switch (FIG. 4A).

The separation distance between the blades (4a,4b) generally matches the thickness of the fixed contacts (3a,3b), so in the closed position of the switch (FIG. 4A), the two blades are overlapped and in contact with the fixed contacts, one blade (4b) in contact with the lower side of the fixed contacts, and the other blade (4a) in contact with the upper side of the fixed contacts. The movable contact (4) in the closed position of the switch, is placed in the space in between the first and second fixed contacts (3a,3b), thus, the movable contact (4) is coaligned with the fixed contacts (3a,3b).

In this closed position, a nominal current (I) circulating through the fixed contacts (3a,3b) would split in two currents (I/2) while circulating through the two blades (4a,4b), as illustrated in FIG. 4A.

According to the disclosure, the above-described switch (1) incorporates two equipotential connecting members, namely a first equipotential connecting member (6a) electrically connecting in the closed position of the switch (1), the first fixed contact (3a) with the two blades (4a,4b) at one end of the blades, and a second equipotential connecting member (6b) electrically connecting the second fixed contact (3b) with the two blades (4a,4b) at the other end of the blades, as shown in FIGS. 3A & 4A. Additionally, the two equipotential connecting members (6a,6b) are configured to maintain the fixed and the movable contacts pressed together in the closed position of the switch, in a way in that it is assured that the fixed and the movable contacts remain at the same electric potential, even if they are separated due to repulsion forces caused by a short-circuit current. In this way and as represented in FIG. 4A, the voltages: (Va) at the first fixed contact (3a), (Vb) at the upper blade (4a) and the voltage (Vc) at the first equipotential connecting member, are the same.

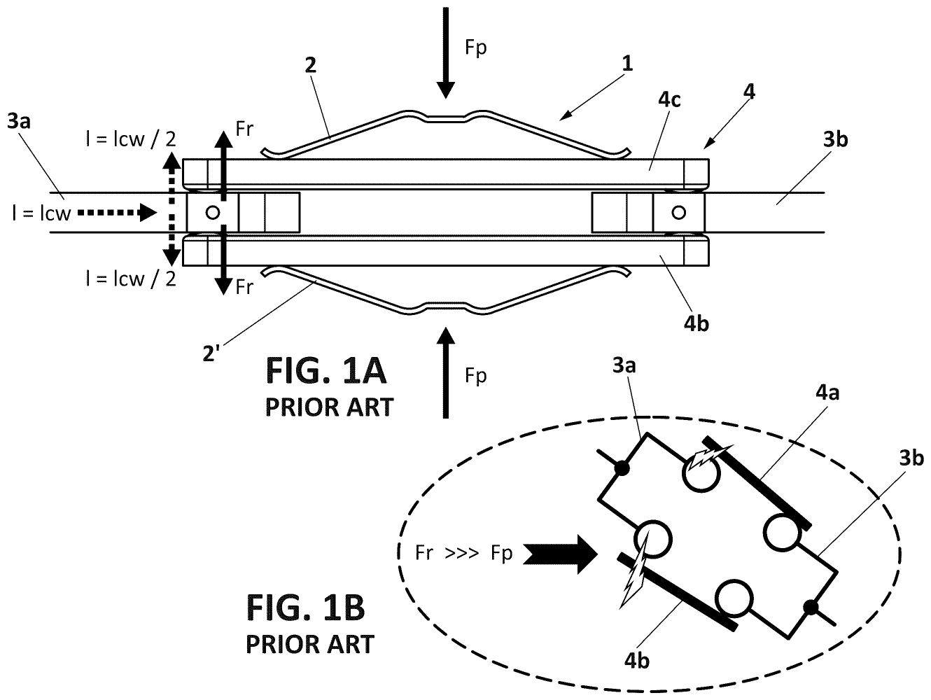

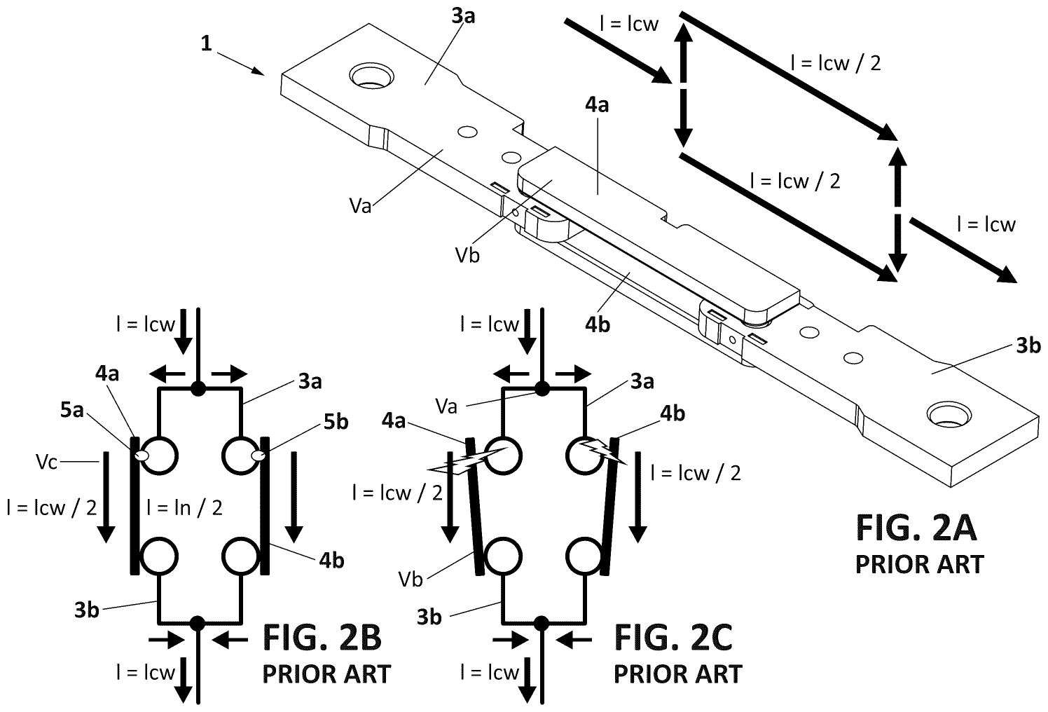

It should be noted that two equipotential connecting members (6a,6b) are configured to maintain the fixed and the movable contacts pressed together, not to serve as pressing members as the pressing members (2, 2′) of FIG. 1A, but to assure the electrical connection between fixed and movable contacts while the movable contacts levitate from the fixed contacts.

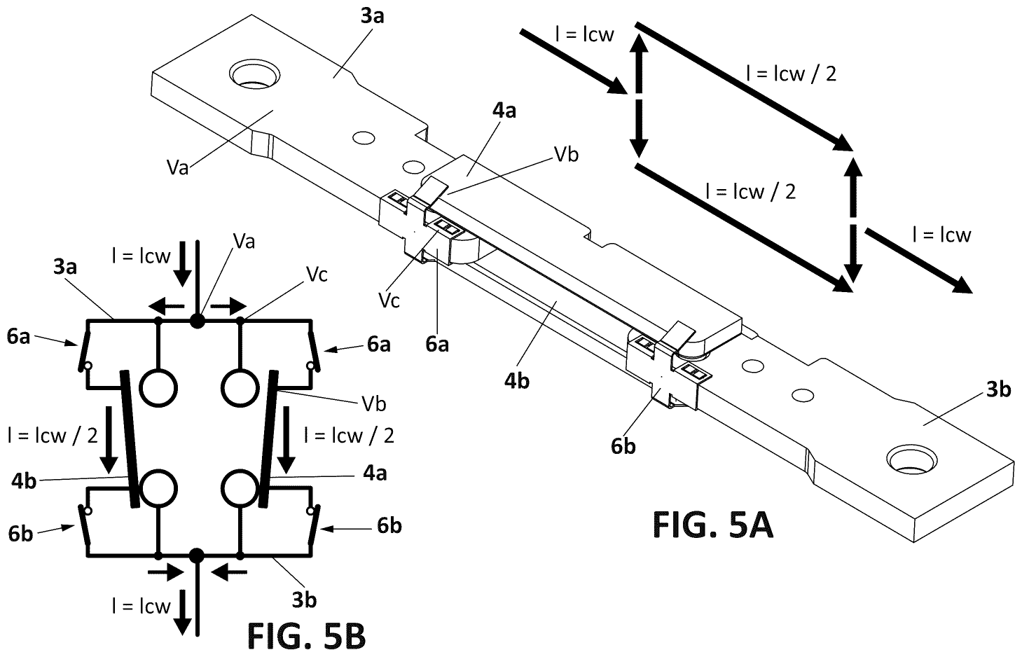

In the preferred embodiment shown in the figures, each of the equipotential connecting member (6a,6b) is attached permanently to a fixed contact (3a, 3b) and it is configured to make contact with the blades (4a, 4b) in the closed position of the switch. For that purpose, a part of each equipotential connecting member (6a,6b) is a flexible metal plate, which overlaps one of the blades (4a,4b) and press that blade against a fixed contact in the closed position of the switch. Due to that configuration of the equipotential connecting members (6a,6b), in the event that a short-circuit circulates through the switch, and the blades (4a, 4b) and fixed contacts (3a,3b) are separated by repulsion forces, the blades (4a, 4b) and the fixed contacts (3a,3b) would remain electrically connected by means of an equipotential connecting member (6a,6b), so that fixed contacts and the blades of the movable contact remains at the same electric potential, as represented in FIG. 5B.

In other preferred embodiments, the equipotential connecting members (6a,6b) are attached to the blades (4a, 4b), and are pressed against the fixed contacts (3a,3b) in the closed position of the switch (1).

It should be understood that the working principle of the disclosure, can be applied to other type of switches different than the one shown in the figures being described.

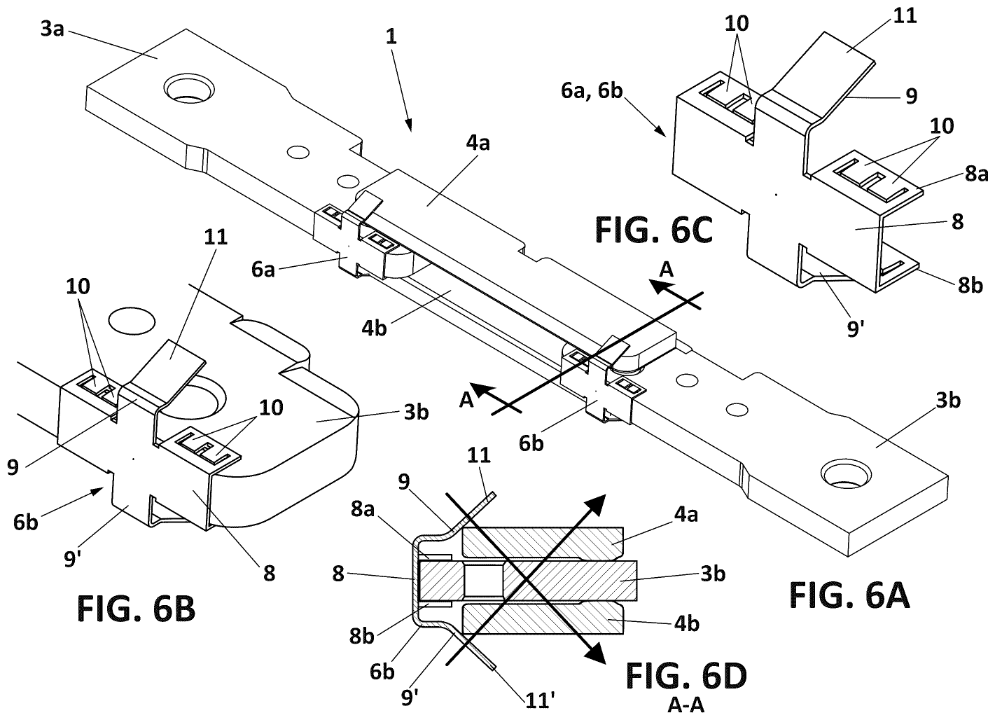

A preferred configuration of the equipotential connecting member (6a,6b) is more clearly shown in FIGS. 6A to 6D. Each equipotential connecting member (6a,6b) is embodied as a metallic plate conformed as a clamp, which embraces the fixed and the movable contacts at the overlapped parts of the fixed and movable contacts, in the closed position of the switch.

The equipotential connecting member (6a,6b) press the blades and fixed contact together in the closed position of the switch. Each equipotential connecting member (6a,6b) has a central part (8) having a U-shaped configuration in a cross-sectional view, and first and second tabs (9,9′) protruding in opposite directions from the central part (8). The central part (8) is configured and dimensioned so that a fixed contact (3a,3b) can be tightly received inside, so that each member (6a,6b) is attached to an edge of a fixed contact (3a,3b) by means of the respective central part (8), as better shown in FIG. 6B. For that purpose, the central part (8) has wings (8a,8b) conformed to have anchors (10) which engage with the respective fixed contact (3a,3b).

Each tab (9,9′) has a first section which is coplanar with the central part (8), and a second section which is folded with respect to the first section.

In the embodiment of FIGS. 6A to 6D, a second section of each tab (9,9′) is an inclined with respect to a plane defined by a blade (4a,4b), and these inclined parts (11,11′) are flexible parts which are flexed due to its contact with the blades (4a,4b) in the closed position of the switch, as shown for instance in FIG. 6D. The inclined parts (11,11′) diverge with respect to the central part (8). In this way, the inclined parts (11,11′) are pressed against a blade (4a,4b) of the movable contact, and exert pressure on the blades due to its flexible characteristic.

Furthermore, also as shown in FIG. 6D the the inclined parts (11,11′) of each member (6a,6b) are pressed against the blades (4a,4b) in a direction (indicated by arrows in FIG. 6D) towards a contacting surface at which the fixed contact and the blades (4a, 4b) are overlapped and in contact. Additionally, inclined parts (11,11′) extend above the blades (4a, 4b).

With the above-described configuration and arrangement of the equipotential connecting members (6a,6b), as it can be appreciated from FIG. 6D, even if the blades (4a, 4b) lift off from one of the fixed contact (3, 3′) as a consequence of a high-current entering that fixed contact, the blades (4a, 4b) would remain connected to the respective equipotential connecting member (6a,6b), thus, remaining at the same electric potential than the fixed contact.

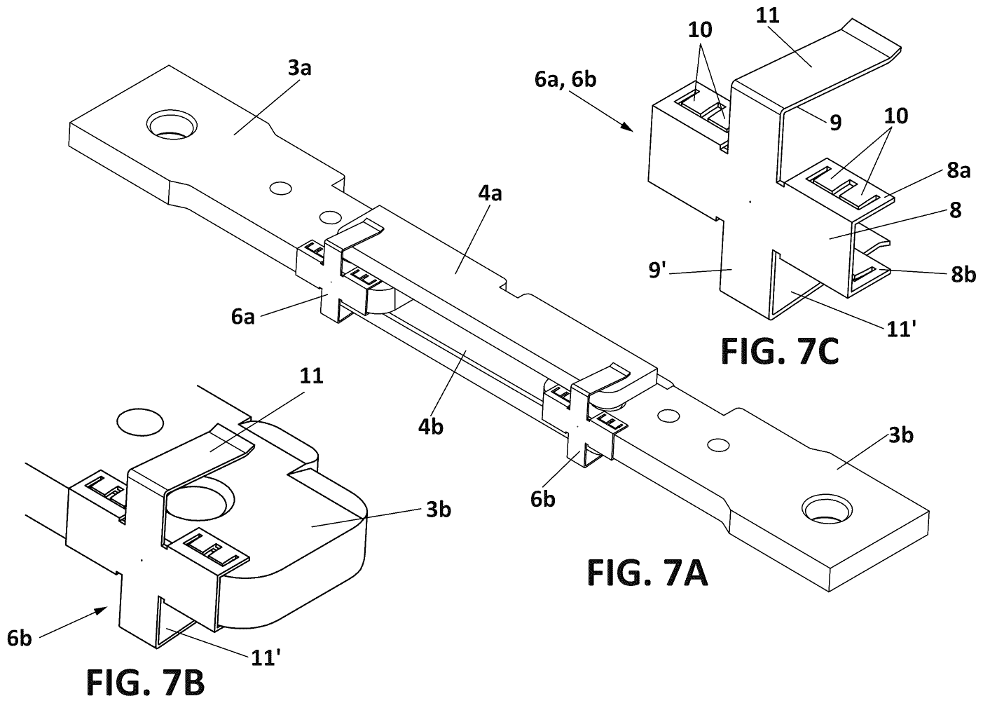

FIGS. 7A to 7C show an alternative configuration of the equipotential connecting members (6a,6b), which have the same parts as the members described above in relation to FIG. 6A, that is, they also have a central part (8) with wings (8a, 8b) both provided with anchors (10), and first and second tabs (9,9′) protruding in opposite directions from the central part (8). However, in this embodiment the first and second tabs (9,9′) are configured as a L-shaped flexible parts (11,11′), which are flexed by its contact with the flanges (4a, 4b) so that these parts (11, 11′) are pressed against the fixed contacts, and are placed above the flanges (4a, 4b) in the closed position of the switch (1). The two arms of the L-shaped parts are arranged to form an angle within the range 85° to 90°.

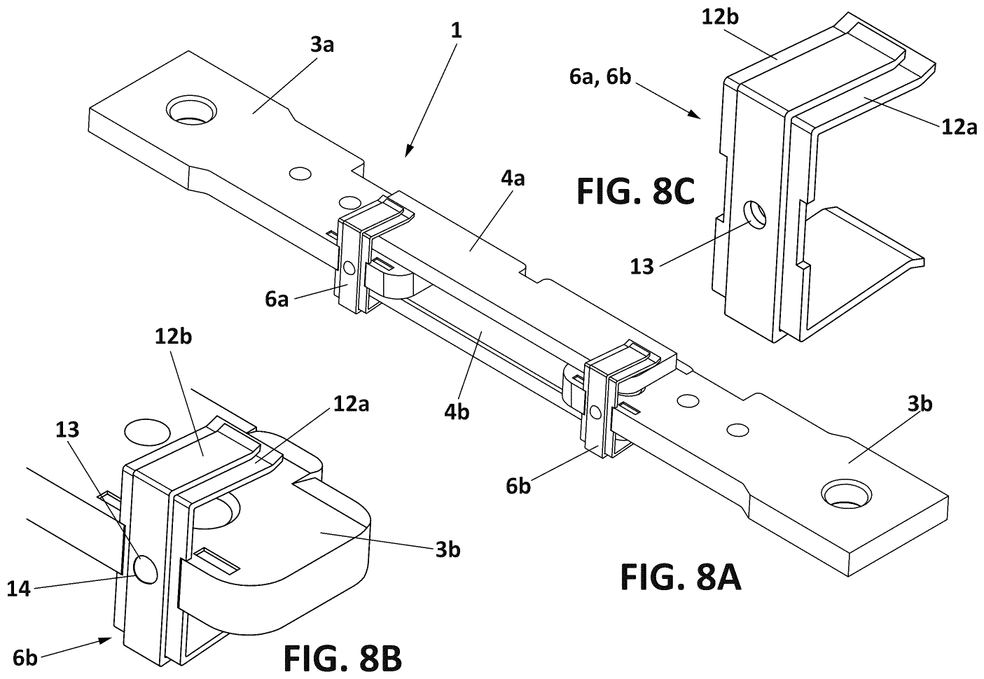

In the alternative embodiment of FIGS. 8A to 8C, the equipotential connecting members (6a,6b) are formed as double-wall bodies, that is, each member has a first wall and a second wall with a similar configuration than the first wall, and overlapped and in contact with the first wall. That configuration of the equipotential connecting members (6a,6b), is a reinforced version of the same, capable of withstanding higher repulsion forces. Particularly, in the case of FIGS. 8A to 8C, each equipotential connecting member (6a,6b) has a first U-shaped wall (12a) and a second U-shaped wall (12b) overlapped and in contact with the first U-shaped wall (12a). These two walls (12a, 12b) have overlapping passing-through bores (13), for their attachment to a fixed contact (3a, 3b) by means of a rivet (14).

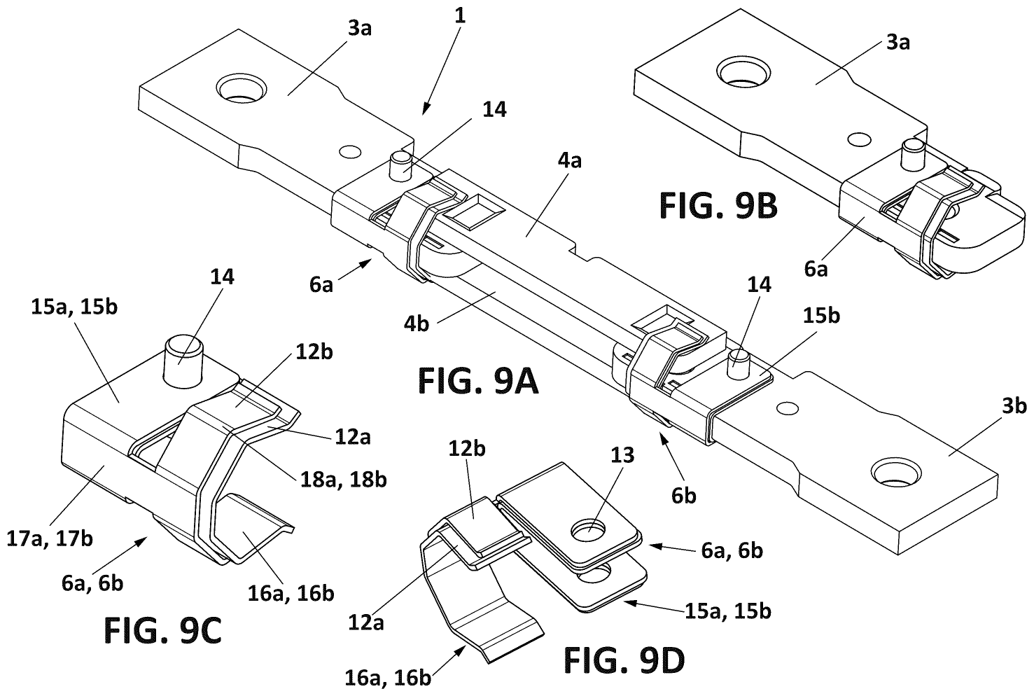

In the alternative embodiment of FIGS. 9A to 9D, each of the equipotential connecting member (6a,6b) has an attaching part (15a, 15b) and a clamping part (16a, 16b) both joined by a central part (17a, 17b). The attaching part (15a, 15b) is U-shaped and it is adapted to be attached permanently to a fixed contact (3a, 3b) for example by means of a perforations (13) and a rivets (14). The clamping part (16a, 16b) has two tabs protruding in opposite directions from the central part (17a, 17b), wherein each tab has a folding line (18a, 18b) which forms two inclined sections. Preferably, each of the equipotential connecting member (6a,6b) is also formed as double-wall bodies having a first wall (12a) and a second wall (12b), wherein the second wall (12b) replicates the shape of the first wall (12a), and it is overlapped and in contact with the first wall (12a).

As it can be appreciated from the above-described embodiments and figures, the equipotential connecting members (6a,6b) can be easily installed during the manufacturing process of a switch without the need of modifying an existing design of the switch components, that is, the disclosure can be easily retrofitted into existing assembly manufacturing process of a switch of the above-described type.

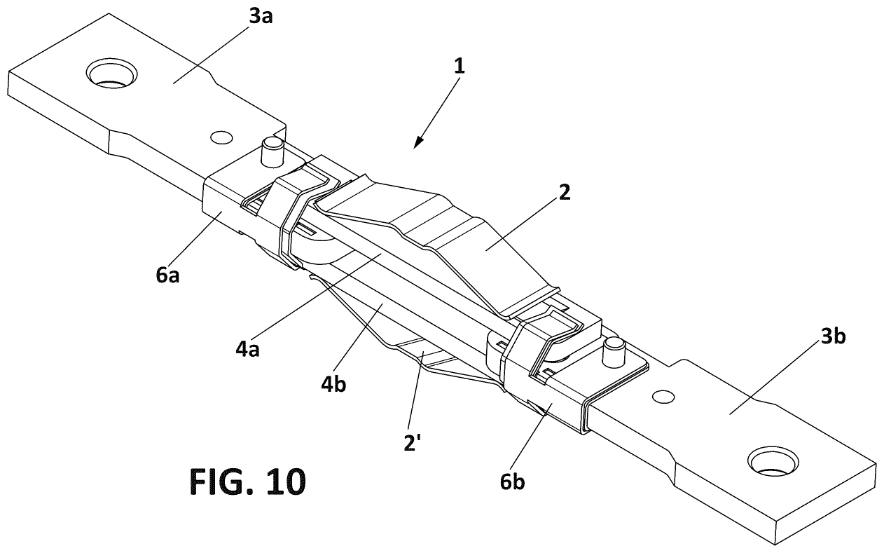

As represented in FIG. 10, the switch (1) of the disclosure in addition to the equipotential connecting members (6a,6b), can be provided with conventional press members (2,2′) in the form of a leaf spring.

Based on any of the previously described embodiments, a multipole switch can be formed by arranging several switches (1) parallel to each other, and having all the movable contacts (4) mounted on a common carrier (not shown) to move simultaneously.

The method of the disclosure is illustrated in any of the previously described embodiments of the disclosure, wherein the method involves maintaining a fixed contact and a movable contact of the switch at the same electric potential in a closed position of the switch, by clamping and pressing together the fixed and movable contacts by means of an equipotential connecting member made of a flexible metallic plate.

1. A switch comprising: at least one fixed contact and at least one movable contact (4), wherein the movable contact is displaceable between a closed position of the switch in which the fixed contact and the movable contact are electrically connected, and an open position of the switch in which the fixed contact and movable contact are separated, wherein
the switch further comprises at least one equipotential connecting member electrically connecting the fixed contact and the movable contact in the closed position of the switch, and wherein at least a part of the equipotential connecting member presses against the fixed contact and/or the movable contact in the closed position of the switch, to maintain the fixed and the movable contacts at the same electric potential.

2. The switch according to claim 1, wherein in the closed position of the switch, a part of the fixed contact and a part of the movable contact are overlapped and in contact at a contacting surface there in between, and wherein the equipotential connecting member is configured as a clamp or clip which embraces the fixed contact or the movable contact or both, at the overlapped parts of the fixed and movable contacts.

3. The switch according to claim 1, wherein in the closed position of the switch, the fixed contact and the movable contact are overlapped and in contact at a contacting surface, and wherein the part of the equipotential connecting member which presses against the fixed contact and/or the movable contact, press in a direction towards that contacting surface.

4. The switch according to claim 1, wherein the part of the equipotential connecting member which presses against the fixed contact and/or the movable contact, is a flexible metal plate configured to exert pressure on the fixed contact and/or the movable contact in the closed position of the switch, due to its flexible characteristic.

5. The switch according to claim 1, wherein a part of the equipotential connecting member is permanently attached to the fixed contact, and the part configured as a flexible metal plate is placed on the movable contact and press the movable contact towards the fixed contact in the closed position of the switch.

6. The switch according to claim 1, wherein the equipotential connecting members are formed as double-wall bodies having a first wall and a second wall with a similar configuration than the first wall, wherein the two walls are overlapped and in contact.

7. The switch according to claim 1, wherein the movable contact is composed by two blades embodied as generally flat and elongated bodies, each one formed by a rigid metallic piece, wherein the blades are separated and parallel to each other.

8. The switch according to claim 1, comprising first and second fixed contacts formed by generally flat and elongated bodies, each one made of a rigid metallic piece, wherein the first and second fixed contacts are aligned in a first direction, and wherein the movable contact is linearly displaceable in a second direction orthogonal to first direction.

9. The switch according to claim 8, wherein the first fixed contact and the second fixed contact are spaced apart from each other, and wherein the movable contact in the closed position of the switch, is placed in the space in between the first and second fixed contacts and it is electrically connected to the two fixed contacts, and wherein the switch further comprises a first equipotential connecting member connecting the movable contact with the first fixed contact, and a second equipotential connecting member connecting the movable contact with the second fixed contact in the closed position of the switch.

10. The switch (according to claim 1, wherein each equipotential connecting member has a central part having a U-shaped shape, wherein The central part is configured and dimensioned so that a fixed contact can be tightly received inside, so that each member is attached to an edge of a fixed contact by means of the respective central part, and wherein each equipotential connecting member has first and second tabs protruding in opposite directions from the central part. and wherein each one of the first and second tabs has a part inclined with respect to a plane defined by a blade, and these inclined parts are flexible parts which are flexed due to its contact with the blades in the closed position of the switch.

11. The switch according to claim 10, wherein each tab has a first section which is coplanar with the central part, and a second section which is folded with respect to the first section of the tab.

12. The switch (according to claim 1, wherein each of the equipotential connecting member has an attaching part and a clamping part both joined by a central part, wherein the attaching part is U-shaped and it is adapted to be attached permanently to a fixed contact, and wherein the clamping part has two tabs protruding in opposite directions from the central part, wherein each tab has a folding line which forms two inclined sections.

13. A multipole switch comprising an array of switches that open and close simultaneously, wherein each switch is the switch defined in claim 7.

14. A method for operating a switch for switching On and Off an electric current, the method comprising the step of maintaining a fixed contact and a movable contact of the switch at the same electric potential in a closed position of the switch, while a short-circuit current circulates through the switch.

15. The method according to claim 14, wherein the fixed contact and movable contacts are maintained at the same electric potential in a closed position of the switch, by clamping and pressing together the fixed and movable contacts by means of an equipotential connecting member made of a flexible metallic plate.
